(19) United States
(12) Patent Application Publication
(10) Pub. No.: US 2006/0215414 A1
(43) Pub. Date: Sep. 28, 2006

(54) Interior lamp, especially for a vehicle

(75) Inventor: Carsten Lauber, Bermatingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChyslar AG, Stuttgart (DE)

(21) Appl. No.: 10/534,693

(22) PCT Filed: Jul. 8, 2004
(86) PCT No.: PCT/EP04/07499

§ 371 Date: Apr. 14, 2006

(30) Foreign Application Priority Data
Jul. 15, 2003 (DE) 103 52 158.6

(51) Int. Cl. F21V 9/00

(52) U.S. Cl. 362/511; 362/488; 362/544; 362/545

(57) ABSTRACT

An interior lamp, especially for a vehicle, which has a normal illuminating function and an ambient illuminating function for the purpose of providing ambient illumination for the interior. An incandescent lamp provides the normal illuminating function. Light from the lamp radiates through an optical waveguide arranged as a diffusing screen.

This application claims priority to International Patent Application No. PCT/EP2004/007499, filed Jul. 8, 2004, designating the United States of America, and German Application DE 103 32 158.6 filed on Jul. 15, 2003, the entire disclosure of which is incorporated herein by reference.

### BACKGROUND AND SUMMARY OF THE INVENTION

The invention relates to an interior lamp for a vehicle, which has a normal illuminating function and an ambient illuminating function for the purpose of providing ambient illumination for the interior.

A generic interior lamp is known, for example, from the E class Mercedes-Benz. An interior lamp is arranged in the roof-operating unit and has, as the normal illuminating function, an incandescent bulb whose light is diffused by a conventional diffuser screen into the vehicle interior. As an additional lamp, an ambient lamp is provided as the second lamp which comprises a curved optical waveguide into which the light from a light-emitting diode is introduced laterally. This light is guided through the optical waveguide and passes to the outside as ambient light at the interference points over the entire area of the optical waveguide.

German Patents DE 100 32 927 A1 and DE 101 49 044 A1 disclose an illumination device for the purpose of illuminating the interior of a motor vehicle. The illumination device has at least one luminous device and at least one plate-like or rod-like optical waveguide which is arranged, with its light injection area, in the light irradiation region of the luminous device. The optical waveguide has a plurality of light output points which are spaced apart from the light injection area. In at least one beam path, which extends from the light injection area to one of the light output points, the optical waveguide has at least one reduction point, which is spaced apart from the light output point, which forms a shield, and which is arranged and/or formed such that the light intensity of the light emerging at the individual light output points is damped to differing degrees.

The reduction point is provided with a light-impermeable cover at least on the light output side of the optical waveguide.

One disadvantage of the prior art device is that the two lamps require a lot of physical space in the roof-operating part. In addition to the normal interior illumination there is also the ambient illumination which is arranged on the right and left in the roof-operating part and which surrounds the roof-operating unit in the form of a ring of light.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a roof-operating part with interior illumination,

FIG. 2 shows a schematic sectional illustration of an interior lamp having a normal and an ambient light function, and

FIG. 3 shows a schematic sectional illustration of an interior lamp having a normal light function with an integrated reading lamp and an ambient light function.

### DETAILED DESCRIPTION OF THE DRAWINGS

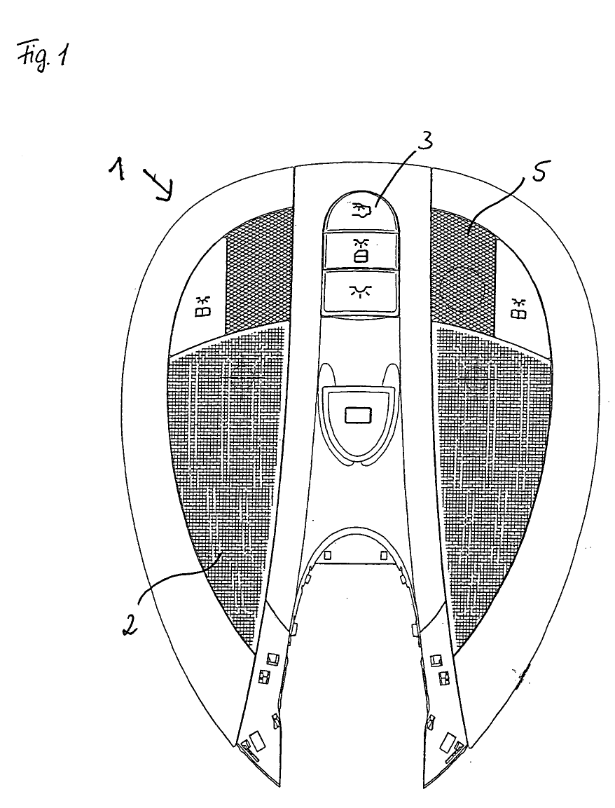

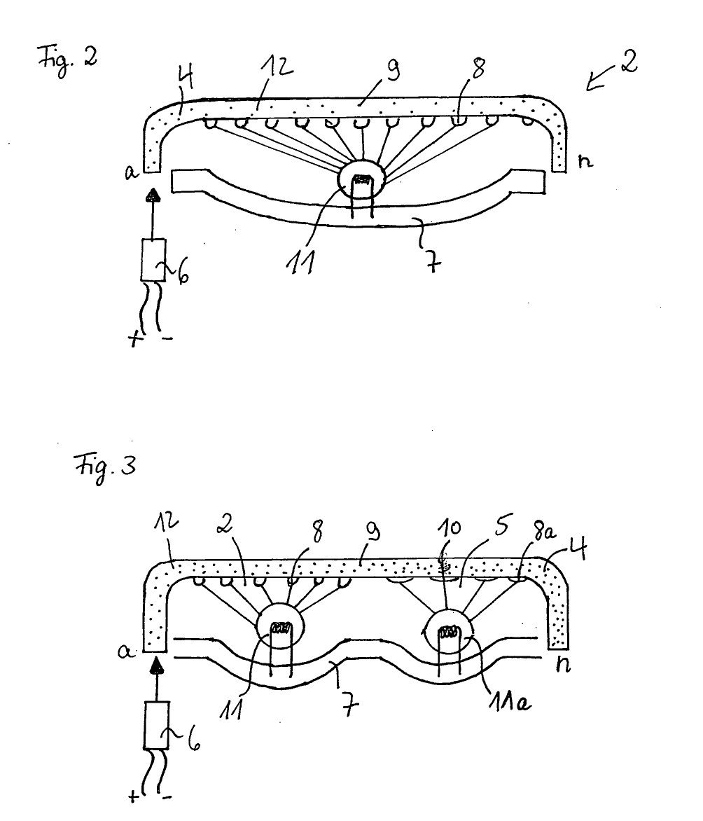

FIG. 1 shows a roof-operating part 1, which has a region having operating elements 3 for the purpose of operating the interior illumination and an interior lamp 2. This interior lamp 2 has a normal and an ambient light function. The normal light function has, as the normal interior illumination 2, a diffusing screen 12 as a cover which diffuses the light from the incandescent bulb 11, which is arranged below the diffusing screen 12, to the outside as shown in FIG. 2. The diffusing screen 12 is an optical waveguide 4. Light is injected into this optical waveguide 4 laterally by a light-emitting diode 6, propagates along the optical waveguide 4 and is output as ambient light at interference points 9 provided for this purpose in the optical waveguide 4. The surface structure may have, for example, a regular or irregular roughness which deviates from a smooth surface, microprisms, grooves, a varnish or similar optical interference, at which total reflection of the light guided in the optical waveguide 6 does not occur or only occurs to a limited extent, and the light is thus output from the optical waveguide 6. The ambient light function 6 is only active if the normal light function 11 is switched off. The normal light function 11 is only active when the ambient light function 6 is switched off. The different light functions 6, 11 can be switched on by means of an operating element provided for this purpose. However, they can also be switched on automatically, for example during the day the normal interior illumination 2 is connected when the doors are opened, whereas the ambient illuminating function is activated by means of a light or rain sensor or when the headlights are switched on.

FIG. 2 shows a schematic sectional illustration of an interior lamp 2 having a normal and an ambient light function. The normal light function is in the form of an incandescent lamp 11, whose light is directed by a reflector 7 in the direction of the diffusing screen 12. Diffusing points 8 are arranged on the inside of this diffusing screen 12 and diffuse the light into the interior in all directions. These diffusing points 8 are usually arranged on the inside of the diffusing screen 12 such that the interior lamp 2 has a smooth surface, as is desired from the design. Technically, the diffusing points 8 may, however, also be located on the surface of the diffusing screen 12 and diffuse the light into the interior of the vehicle only when light has passed through the diffusing screen 12. The normal 2 and the ambient light function 4 are switched on independently of one another. The ambient illumination 6 is switched off when the normal light function 11 is activated, and the normal light function 11 is switched off in the case of the ambient light function. A light-emitting diode 6 is activated for the ambient light function 4, the light from the light-emitting diode 6 passing into the optical waveguide 12, which acts as a diffusing screen 12 in the case of the normal light function 2. This light is injected into the optical waveguide from below at the injection point a into the optical waveguide. However, the light may also be injected laterally or from above. This depends on the direction in which the injection point a is formed. This light is guided in the optical waveguide 12 from its point of entry a up to the other end of the optical waveguide n. However, a plurality of injection points a to n can also arranged for the light. The light may in this case be introduced into the optical waveguide at a, b and/or n. A mirror may also be arranged at the injection point n, with the result that the light is passed back again to the point of entry a. As the light passes through the optical waveguide 4, it is diffused into the interior at interference points 9 provided in the optical waveguide 12. The interference points 9 may be arranged at the surface of the optical waveguide 12, and may have a regular or irregular roughness which deviates from a smooth surface, microprisms, grooves and/or a varnish or a similar coating, at which total reflection of the light guided in the optical waveguide 6 does not occur or occurs only to a limited extent. The interference point 9, however, are preferably arranged in the interior of the optical waveguide 12 and is formed, for example, by diffusers and microparticles found there or by points at which the optical waveguide resistance is increased in comparison to a region adjacent thereto. The at least one interference point 9 thus represents a control element which makes it possible for the design engineer, by correspondingly arranging and/or forming the interference points 9, to match the light distribution at the light output area of the optical waveguide 12 to a light distribution which is desired for the respective illumination task. In this case, it is particularly possible for the interference points 9 to be arranged and/or formed such that at the light output area of the optical waveguide 4 to be matched to a light distribution which is desired for the respective illumination task. In this case, it is particularly possible for the interference points 9 to be arranged and/or formed such that a light output or light intensity distribution achieved at the light output area of the optical waveguide 12 is uniform to the human eye. The light diffused by the interference points 9 into the interior lamp 2 is diffused by the reflector 7 back to the optical waveguide 12 and passes from there into the interior of the vehicle in the same way as the normal light function 2. This reflector 7 brings about increased luminous efficiency of the ambient light function 4 owing to the back-reflection of the light. The optical waveguide 12 is preferably made of transparent plastic such that it is flexible and allows the light emitted in the case of the normal illuminating function 2 to pass directly into the interior. In order to diffuse the light uniformly into the vehicle interior, the inside of the diffusing screen 12 is fluted. These fluted formations then form the diffusing points 8 for the purpose of diffusing the light into the vehicle interior. The flexibility of the optical waveguide means that the diffusing screen 12 can be adapted to any desired surface, with the result that there are no limits to the design as regards its arrangement and configuration. It is thus also possible for the diffussing points 8 to assume the function of the interference points 9 if an optical waveguide is used which has this property of outputting the light from the optical waveguide at these diffusing points 8.

The interior lamp 2 having a normal illuminating function 2 and an ambient illuminating function for the purpose of providing ambient illumination for the interior may also be realized by means of OLED technology. OLEDs are transparent plastic disks which emit light themselves when a voltage is applied. In this case, an incandescent lamp 11 is provided for the normal illuminating function 2, and this lamp 11 radiates through a disk arranged as a diffusing screen 12, and the disk 12 emits light itself for the ambient illuminating function by a voltage being applied.

In FIG. 3, a reading lamp 5 is arranged below the optical waveguide 12, which is in the form of a diffusing screen 12, in addition to the normal interior lamp 2. This reading lamp 5 in this case has a dedicated luminous device 11a. Alternatively, the part of the diffusing screen 12 which is associated with the reading lamp 5 has different diffusing points or interference points 10 than the part associated with the normal interior lamp 2, with the result that the light from the reading lamp source 11a is diffused into the vehicle interior in a more directed fashion, owing to the interference points 10 on the diffusing screen 12, so as to provide a good reading light. The interference points 8, 9 are formed such that the light output points, which are preferably connected to one another to form a continuous light output area, have essentially the same light intensity.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. An interior lamp for a vehicle, which has a normal illuminating function and an ambient illuminating function for the purpose of providing ambient illumination for the interior,
said lamp comprising;
an incandescent lamp providing normal illuminating function; and
an optical waveguide arranged as a diffusing screen wherein light from said lamp radiates through said diffusing screen.

2. The interior lamp as claimed in claim 1, further comprising at least one light-emitting diode for providing said ambient illumination, wherein light from said light-emitting diode is injected into the optical waveguide and said light is output at a plurality of interference points.

3. The interior lamp as claimed in claim 1, further comprising
a further luminous device arranged as a reading lamp below the diffusing screen to provide a further illuminating function in addition to said normal illuminating function.

4. The interior lamp as claimed in claim 3,
wherein the diffusing screen is associated with the incandescent lamp by first diffusing points, and the further luminous device is associated with the diffusing screen by second diffusing points.

5. The interior lamp as claimed in claim 2, further comprising:
in that a reflector arranged such that light diffused by the interference points into the lamp is reflected back to the optical waveguide (12) such that it passes into the vehicle interior in the same manner as the normal light function.

6. The interior lamp as claimed in claim 2, wherein
the interference points are formed to provide light output points in order to form a continuous light output area, have essentially a constant light intensity.

7. The interior lamp as claimed in claim 1 wherein
the normal and the ambient light function are switched on independently of one another, the ambient illumination being switched off when the normal light function (11) is activated, and the normal light function being switched off during activation of the ambient light function.

8. An interior lamp for a vehicle, which has a normal illuminating function and an ambient illuminating function for the purpose of providing ambient illumination for the interior, said lamp comprising
an incandescent lamp for providing the normal illuminating function; and
a disk arranged as a diffusing screen for light from said lamp wherein said disk emits light for the ambient illuminating function by a voltage being applied.
